(19) United States
(12) Patent Application Publication
(10) Pub. No.: US 2019/0232403 A1
(43) Pub. Date: Aug. 1, 2019

(54) MASSAGER WITH JIG SAW COUPLING SHAFT

(71) Applicant: Alec Candelaria, Phoenix, AZ (US)

(72) Inventor: Alec Candelaria, Phoenix, AZ (US)

(21) Appl. No.: 16/263,189

(22) Filed: Jan. 31, 2019

Related U.S. Application Data
(60) Provisional application No. 62/624,490, filed on Jan. 31, 2018.

(51) Int. Cl. B23D 51/10; A61H 23/02; B23D 49/11; B23D 49/14

(52) U.S. Cl. CPC B23D 51/10; A61H 23/02; A61H 2201/1669; B23D 49/14; A61H 2201/0157; B23D 49/11

(57) ABSTRACT

A massager having a shaft with a blade that allows the massager to be coupled to a conventional jig saw. The massager has a massage head that is shaped to provide massaging and is secured to a mounting flange using a ball interconnect and a washer. The blade has an end configured to engage the blade receiving mechanism of a conventional jig saw. Operation of the jig saw imparts reciprocal movement of the massage head for massaging activities.

### CROSS-REFERENCE TO RELATED APPLICATIONS

The present application claims priority to U.S. Provisional App. 62/624,490, filed on Jan. 31, 2018.

### BACKGROUND OF THE INVENTION

### 1. Field of the Invention

The present invention relates to mechanical massagers and, more particularly, to a massager adapted for coupling to a jig saw.

### 2. Description of the Related Art

Vibration therapy devices and massagers are frequently used to provide muscle relief. These devices can be very expensive, however, making it difficult for users to acquire and maintain. As a result, there is a need for an approach and device that can provide the benefits of vibration therapy without the need for expensive, specialized equipment.

### BRIEF SUMMARY OF THE INVENTION

The present invention is a massager having a coupling shaft that allows the massager to be coupled to a conventional jig saw to provide reciprocal movement of the massage during a massage. The massager has a massage head that is shaped to provide massaging. The massage head is secured to a foam interconnector that is, in turn, secured via an attachment washer to an adaptor. The adaptor is secured to one end of a coupling blade that has another end configured to engage the blade receiving mechanism of a conventional jig saw so that the massager can be securely coupled to and driven in a reciprocal motion by the jig saw and used for massaging.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is an exploded view of a massager with jig saw coupling shaft according to the present invention;

FIG. 2 is a cross-section of a massager with jig saw coupling shaft according to the present invention;

FIG. 3 is a perspective view of a massage ball head for a massager according to the present invention;

FIG. 4 is a foam ball interconnect according to the present invention;

FIG. 5 is a perspective view of an attachment washer according to the present invention;

FIG. 6 is a perspective view of an adapter according to the present invention; and

FIG. 7 is a second perspective view of an adapter according to the present invention;

FIG. 8 is a perspective view of coupling blade according to the present invention;

FIG. 9 is a perspective view of bar massage head coupled to an adapter according to the present invention;

FIG. 10 is a cross-section of bar massage head coupled to an adapter according to the present invention;

FIG. 11 is an exploded view of a Y-shaped adaptor for supporting two massage ball heads according to the present invention;

FIG. 12 is a perspective view of a Y-shaped adaptor for supporting two massage bar heads according to the present invention; and

FIG. 13 is a perspective view of a Y-shaped adaptor having spring biased arms for supporting two massage bar heads according to the present invention.

### DETAILED DESCRIPTION OF THE INVENTION

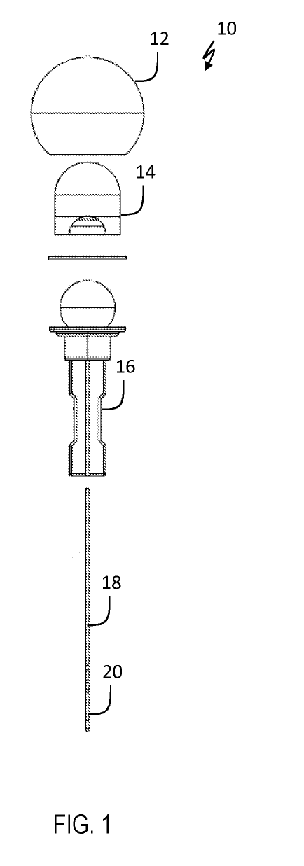

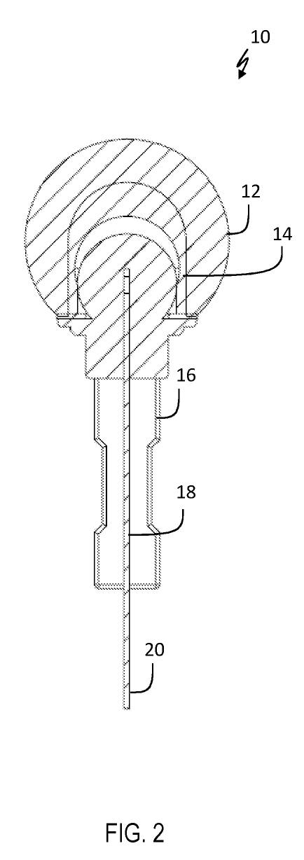

Referring to the figures, wherein like numeral refer to like parts throughout, there is seen in FIGS. 1 and 2 a massager 10 according to the present invention that is adapted for coupling to a jig saw (not shown) for reciprocal movement of massager 10 during a massage using the variable speed motion provided by a conventional jig saw. Massager 10 comprises a massage ball head 12 secured to a foam ball interconnect 14. Foam ball interconnect 14 is coupled to an adaptor 16 through frictional engagement. An attachment washer 18 may be positioned between foam ball interconnect 14 and adaptor 18 to prevent wear between the parts, and to provide cushioning so that the coupling of the two parts is more secure.

Adaptor 16 is secured to a blade 20 having a free end 22 that is configured to engage the blade receiving mechanism of a conventional jig saw so that massager 10 can be securely coupled to and then driven in a reciprocal motion by the jig saw for massaging activities. For example, free end 22 may be formed as a jig saw blade shank for attachment to a jig saw and can be shaped in any way that will allow for free end 22 to be secured to an existing jig saw, such as a conventional T-shank or U-shank.

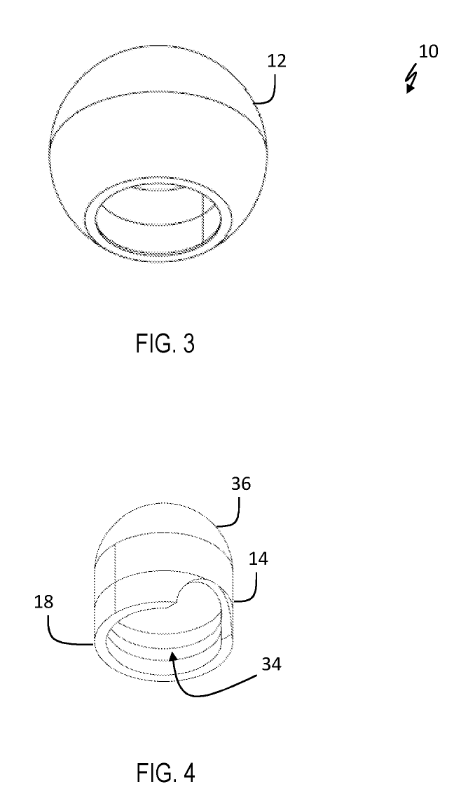

Referring to FIG. 3, massage ball head 12 comprises a partial sphere with a cavity 30 formed therein for receiving foam ball interconnect 14. Massage head 12 is preferably manufactured from resilient plastics and polymers, high density foams, silicone or other rubber, etc. to any hardness (or softness) desired by a user or useful for massaging action. Although massage head 12 is illustrated as being spherical it should be recognized that other shapes may be used to facilitate massaging.

Referring to FIG. 4, foam ball interconnect 14 is generally cylindrical and extends from a base 32 surrounding a cavity 34 to a dome shaped head 32 dimensioned to engage cavity 40 of massage ball head 12. Foam ball interconnect 14 should be made from a hard plastic or resilient material so that foam ball interconnect 14 can frictionally engage adaptor 16. For example, foam ball interconnect 14 can snap engage to adaptor 14 using complimentary geometries.

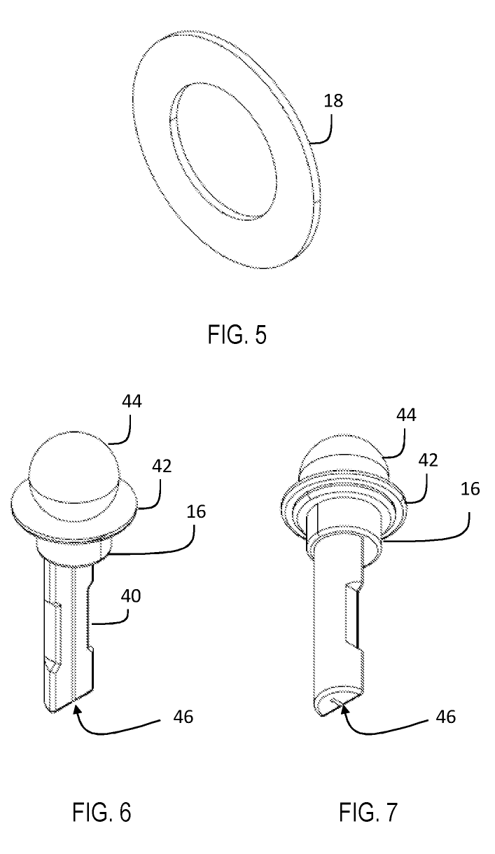

Referring to FIG. 5, attachment washer 18 is a conventional washer that is dimensioned to correspond to base 32 of foam ball interconnect 14 and be positioned therebetween.

Referring to FIGS. 6 and 7, adaptor 16 comprises a shaft 40 extending from a flange 42 that supports a head 44, shown as shaped as a partial hemisphere for snap engagement with foam ball interconnect 14. Shaft 40 includes a slot 46 formed therein for accepting and interlocking with blade 20. Blade 20 may be bonded to adaptor 16 using adhesives, or over-molded when adaptor 16 is formed to secure coupling together. Adaptor 16 may be made from plastic, or even a metal such as steel or aluminum in which case blade 20 could be bolted thereto.

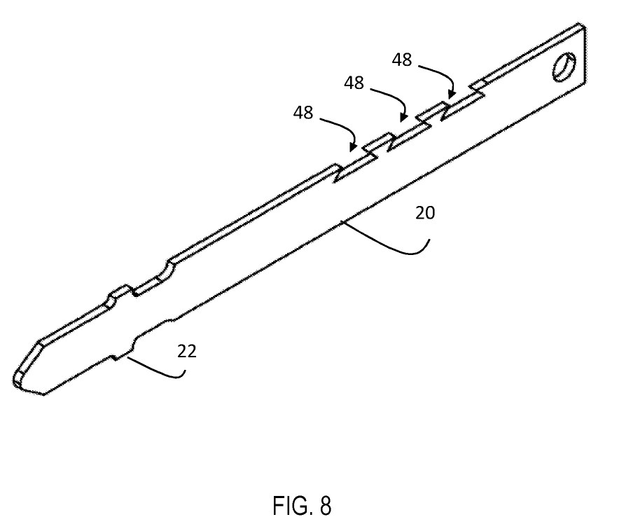

Referring to FIG. 8, blade 20 may include a series of dovetails 48 that mate with corresponding dovetails formed into slot 14 of shaft 40 so that blade 20 can be secured to adaptor 16. It should be recognized that other forms of attachment may be used to secure blade 20 to adaptor 16, including mechanical approaches, adhesives, and even welding, and that other geometries could be used to ensue secure coupling regardless of whether blade 20 and adaptor 16 are secured via over-molding or other approaches such as adhesives. Blade 20 is preferably manufactured from high speed steel for strength and durability.

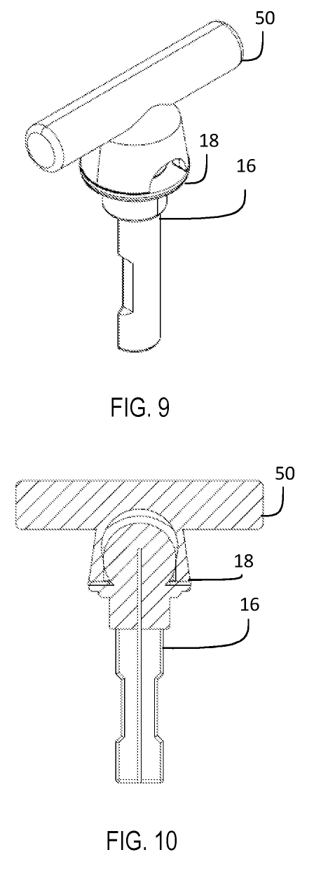

Referring to FIGS. 9 and 10, a bar massager 50 may be attached directly to adaptor 16 in lieu of massage ball head 12 and ball interconnect 14. Washer 18 may be used between bar massager 50 and adaptor 16 for cushioning between the parts and to ensure a secure fit.

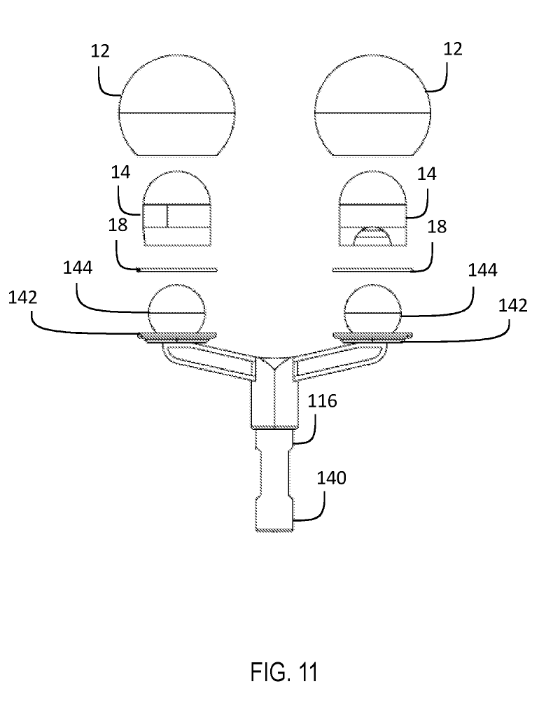

Referring to FIG. 11, a double ball adaptor 116 having two opposing arms 118 and 120 may be used to allow for interconnection of two massage ball heads 12 to a single shaft 140. As seen in FIG. 11, two ball interconnects 14 and two washers 18 may be coupled to double ball adaptor 116 as each arm 118 and 120 includes a separate flange 142 and 144 for mounting a corresponding ball interconnect 14 and ball head 12.

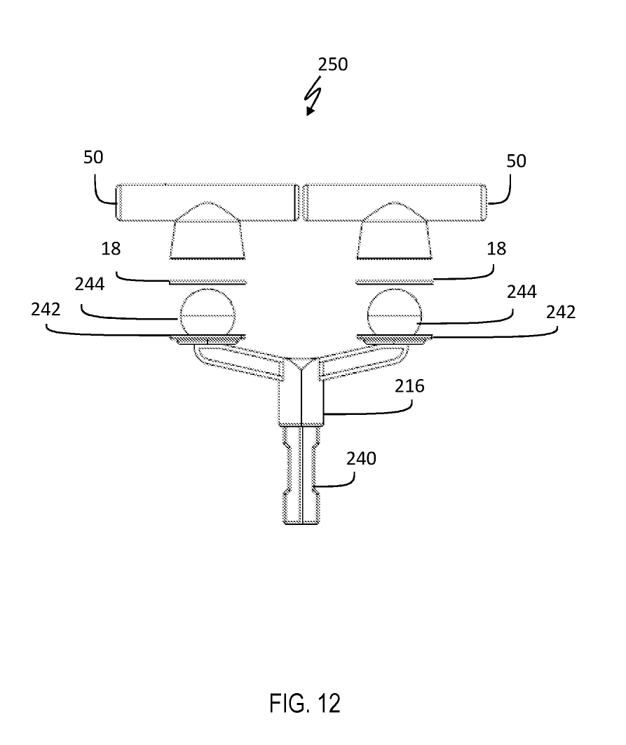

Referring to FIG. 12, a double bar adaptor 250 two opposing arms 218 and 220 may be used to allow for interconnection of two massage bar head 50 to a single shaft 240 as described above with respect to bar massager 50.

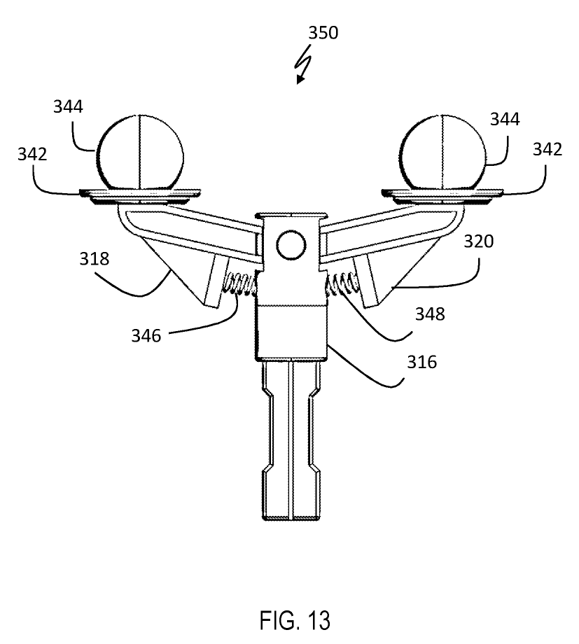

Referring to FIG. 13, a double bar adaptor 350 may have two opposing arms 318 and 320 pivotally mounted to shaft 316, with each arm 318 and 320 biased away from shaft 316 by corresponding springs 346 and 348. Double bar adaptor 350 may be used to allow for interconnection of two massage bar head 50 to a single shaft 240 as described above with respect to bar massager 50.

What is claimed is:

1. A massager, comprising:
an adaptor having a flange, a shank extending from a first side of the flange, and a head extending from a second side of the flange;
a blade secured to the shank of the adaptor and having an end configured for attachment to a jig saw; and
a massage head coupled to the head of the adaptor.

2. A massager according to claim 1, wherein the massage head comprises a ball.

3. A massager according to claim 2, wherein the massage head is coupled to the ball head by a ball interconnect member that is frictionally engaged with the head of the adaptor.

4. A massager according to claim 1, wherein the massage head comprises a bar.

5. A massager according to claim 2, wherein the massage head is coupled directly to the ball head.

6. A massager according to claim 1, wherein the shank of the adaptor has a slot formed therein for accepting the blade.

7. A massager according to claim 6, wherein the blade includes at least one dovetail.

8. A massager according to claim 1, wherein the adaptor includes a first arm supporting the flange and the ball head and a second arm supporting a second flange and a second ball head.

9. The massager according to claim 8, wherein the first arm and the second arm are pivotally mounted to the shank of the adaptor.

10. The massager according to claim 9, wherein the first arm and the second arm are biased away from the shank of the adaptor.

11. A method of massaging, comprising the steps of:
providing a massager formed from an adaptor having a flange supporting a shank on first side and a ball head on a second side, a blade fixed to the shank of the adaptor and having an end configured for attachment to a jig saw, and a massage head coupled to the ball head of the adaptor;
coupling the massager to a jig saw using the end of the blade; and
operating the jig saw so that the massager is reciprocated by the jig saw.

12. The method of claim 11, wherein the massage head comprises a ball.

13. The method of claim 12, wherein the massage head is coupled to the ball head by a ball interconnect.

14. The method of claim 11, wherein the massage head comprises a bar.

15. The method of claim 12, wherein the massage head is coupled directly to the ball head.

16. The method of claim 11, wherein the shank of the adaptor has a slot formed therein for accepting the blade.

17. The method of claim 16, wherein the blade includes at least one dovetail.

18. The method of claim 11, wherein the adaptor includes a first arm supporting the flange and the ball head and a second arm supporting a second flange and a second ball head.

19. The method of claim 18, wherein the first arm and the second arm are pivotally mounted to the shank of the adaptor.

20. The method of claim 19, wherein the first arm and the second arm are biased away from the shank of the adaptor.
